(19) United States
(12) Patent Application Publication
(10) Pub. No.: US 2012/0299724 A1
(43) Pub. Date: Nov. 29, 2012

(54) LOCATION DETERMINATION

(75) Inventors: Vadim KUPER, Yokneam Ilit (IL); Benny SCHLESINGER, Ramat Hasharon (IL)

(73) Assignee: Microsoft Corporation, Redmond, WA (US)

(21) Appl. No.: 13/117,171

(22) Filed: May 27, 2011

(51) Int. Cl. G08B 1/08

(52) U.S. Cl. 340/539.13

(57) ABSTRACT

An embodiment of the invention provides a method of determining a location of a mobile target, that use data characterizing features of the target, data characterizing an environment in which the target is located, and a region of uncertainty for a location of the target provided by a wireless location technology tracker to provide a location for the target having a region of uncertainty that is smaller than that provided by the wireless technology.

### TECHNICAL FIELD

Embodiments of the invention relate to methods of determining a geographic location of a person or object.

### BACKGROUND

Various systems, hereinafter referred to as “tracker systems”, and methods, hereinafter “wireless location technologies” (WILOTs), for wireless determination of a location of a mobile transmitter and/or receiver terminal and a person or object, a “bearer”, carrying or mounted with the mobile terminal, are known. Common transmitter and/or receiver terminals that incorporate and/or are located by WILOT tracker systems are mobile phones, global positioning satellite (GPS) receivers, computers, personal data assistances (PDAs), and workbooks. Among common wireless location technologies employed by tracker systems to determine a location of a mobile transmitter and/or receiver and thereby its bearer, are technologies referred to as trilateration and multilateration. Hereinafter, a transmitter and/or receiver, and/or a device in which it is housed, and/or its bearer, that are located by a tracker system are distinguished as being a “target”, used as a modifier or noun, of the tracker system.

In some WILOT tracker systems using trilateration location technologies and apparatus, signals from three or four transmitters having known locations are received by a target receiver and used to determine a transit time from each transmitter to the target receiver. Each transit time defines a spherical surface having its center at the transmitter for which the transit time was determined and a radius equal to the speed of light times the transit time. Were all the transit times and locations of the transmitters known with absolute accuracy, the spherical surfaces would have a well defined common intersection point, at which intersection point the target receiver would be located.

In practice of course, the transit times and transmitter locations are not known with absolute accuracy, and the spherical surfaces in general do not intersect at a well defined common point. The target receiver (and thereby its bearer), is therefore generally determined to be located in a region of uncertainty (ROU) in which all the spheres come closest to intersecting. A size of the ROU and therefore accuracy of location is dependent on, among other factors, accuracy of synchronization of clocks in the transmitters and receiver that are used to determine transit times between the transmitters and the receiver.

Size of an ROU associated with a location of a target is assumed to be determined by a characteristic linear dimension, such as a radius or diameter, of an area of uncertainty associated with the location. An ROU having a characteristic dimension “X”, in given units of length may be recited as an “ROU of X” in the given units. An ROU, unless otherwise specified is assumed to have a centroid coincident with a target location with which it is associated. For a circular ROU the center of the ROU circle is coincident with the target location.

In tracker systems that use the GPS system, GPS receivers, such as are commonly available for locating vehicles and persons, are located by trilateration using clock signals transmitted from at least three GPS satellites. GPS satellite clock signals are generally accurate to ±200 ns (nanoseconds) relative to Universal Time Coordinated (UTC) and some GPS systems can locate a receiver in an ROU having a characteristic dimension of a few tens of centimeters.

A trilateration technology may of course be used in “reverse”, with a single transmitter transmitting signals to three or four receivers to provide signal transit times useable to determine a location of the transmitter.

In WILOT tracker systems using multilateration location technologies and apparatus, time differences of arrival (TDOAs), or differences in signal strength, of signals from three or more synchronized transmitters received at a receiver are used to determine location of the receiver. Mobile phone networks may use multilateration location systems in which synchronized base station transmitters from different cells in the network transmit signals to mobile terminals, such as mobile phones, personal digital assistants (PDA), and laptop computers, to provide locations for the terminals.

Accuracy of positioning provided by a mobile phone network multilateration technology is generally less than accuracy of location provided by GPS based trilateration technologies. Accuracy may be influenced by size of the cells in the mobile phone network, which may have characteristic dimension that range from about 100 m (meters) to about 3 km (kilometers). Usually, a mobile phone network provides locations having ROUs of dimensions between about 1 km and about 2 km.

As in trilateration location technologies, multilateration location technologies may be operated in “reverse”, with differences between times of arrival or signal strengths of signals from a single transmitter received at three or four receivers being used to determine location of the single transmitter.

Many mobile terminals are now equipped with inertial navigators. An inertial navigator typically comprises a set of accelerometers and gyroscopes and integrates measurements of acceleration provided by the accelerometers and gyroscopes to “dead reckon” (DR) a path traveled by the navigator from a starting location. A terminal point of the integrated path provides a location of the navigator and the navigator's bearer relative to the starting point. Whereas an inertial navigator operates differently than the examples of WILOT systems discussed above, an inertial navigator is considered a WILOT tracker and is distinguished from other WILOT trackers when its differences from other WILOT trackers are pertinent to the discussion.

Errors in a location provided by an inertial navigator propagate and tend to increase as time over which a path is integrated and length of the integrated path increases. Inexpensive accelerometers and gyroscopes comprised in a consumer inertial navigator suffer from drift that degrades accuracy of location provided by the navigator relatively rapidly with integration time and/or path length of a path the navigator integrates. As a result, ROUs for locations determined by commercial inertial navigators may have characteristic dimensions that grow to hundreds of meters over a dead reckoning integration period of about a half hour.

Whereas GPS based tracker systems generally provide the most accurate determinations of locations, they require relatively large amounts of power, and generally do not function for locations of a target for which line of sight from the target to at least three GPS satellites is not available. Various multilateral tracker systems are subject to disturbance by multipath signaling, in which energy from a same signal travels by more than one path to a target receiver, arrives at the receiver at different times, and degrades measurements of signal transit times. Accuracy of both trilateral and multilateral tracker systems is compromised by loss or degradation of synchronization between clocks in the systems. As a result, the various WILOT tracker systems can generate measurements of location characterized by ROUs having dimensions substantially larger than the ROU dimensions referred to above.

### SUMMARY

An embodiment of the invention relates to providing a tracker system and methods that use information regarding an environment in which a target of the tracker system is located to infer a location of the target in the environment.

An environment in which a tracker target moves generally comprises regions, which as a result of features that characterize the regions, and features that characterize the tracker target or behavior of the tracker target, influence respective probabilities that the tracker target might be located in the regions. In accordance with an embodiment of the invention, a tracker system integrates information characterizing features of the environment with a location and associated ROU provided for a target by a WILOT tracker to reduce size of the ROU and improve accuracy with which a location for the target in the environment is determined. In an embodiment of the invention, the tracker system integrates information characterizing features of the tracker target with the WILOT location and ROU to reduce size of the ROU and improve accuracy with which a location of the target is determined. A tracker system, which integrates information characterizing environment and/or target features with WILOT tracker information to infer a location of the target in accordance with an embodiment of the invention, is referred to as an “environment integrating tracker”, hereinafter also referred to as an “ENVINT” tracker.

In an embodiment of the invention, environment characterizing features comprise natural and manmade features of an environment that can influence motion of a tracker target in the environment. A database comprising data that defines characterizing features of an environment, may be referred to as an “environment profile” or “environment profile database”.

Characterizing features of a tracker target may comprise physical and/or psychological features of the target that can affect movement of the target in an environment. Physical features are features that characterize physical ability, “mobility”, of the tracker target to move around in an environment. Psychological features may comprise behavior patterns, preferences, attitudes, and/or social environment that describe and influence how a person moves in an environment and that may vector a person to access or refrain from particular regions of an environment. In embodiments of the invention, for which a tracker target comprises an autonomous robotic vehicle or a semiautonomous vehicle, for example a remote piloted vehicle, psychological features may comprise constraints of and/or idiosyncrasies of an instruction set that controls motion of the vehicle. A database comprising data defining characterizing features of a tracker target may be referred to as a “target profile” or target profile database.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1A schematically shows components of an ENVINT tracker, in accordance with an embodiment of the invention;

FIG. 1B shows a flow diagram of an algorithm that an ENVINT tracker uses to provide a more accurate location and ROU for a tracker target than is provided by a WILOT tracker system, in accordance with an embodiment of the invention;

FIG. 2 schematically shows a rural environment in which an ENVINT tracker operates to determine locations of a tractor-trailer traveling in a rural environment, in accordance with an embodiment of the invention; and

FIG. 3 schematically shows an urban environment in which an ENVINT tracker operates to determine location of a mother and child, in accordance with an embodiment of the invention;

### DETAILED DESCRIPTION

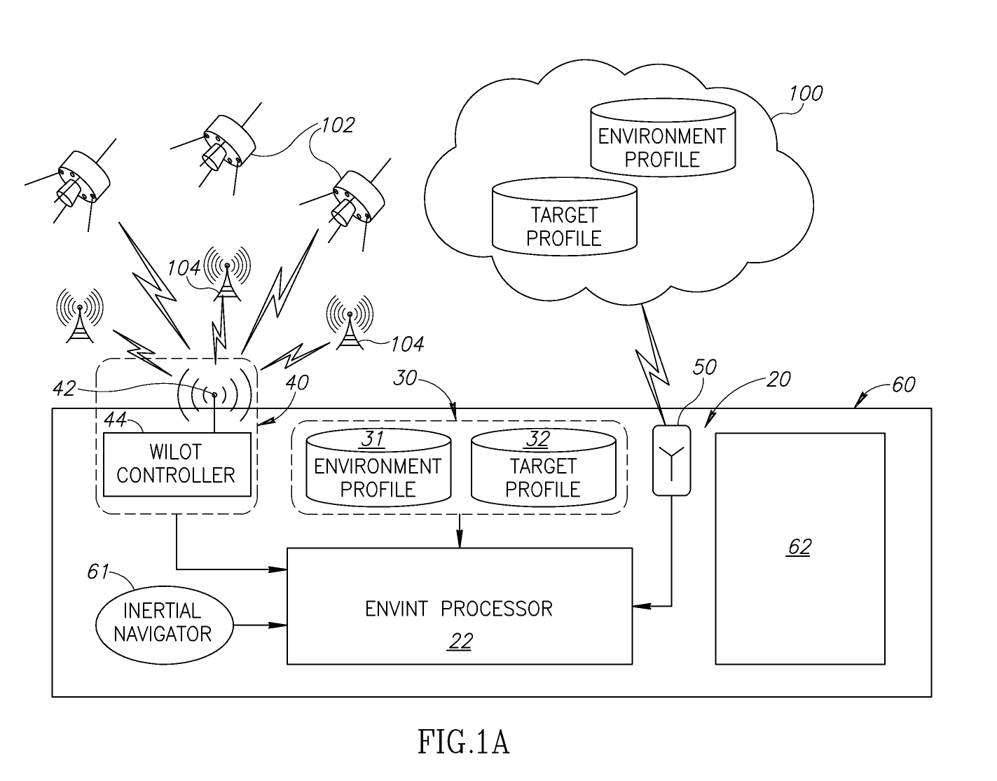

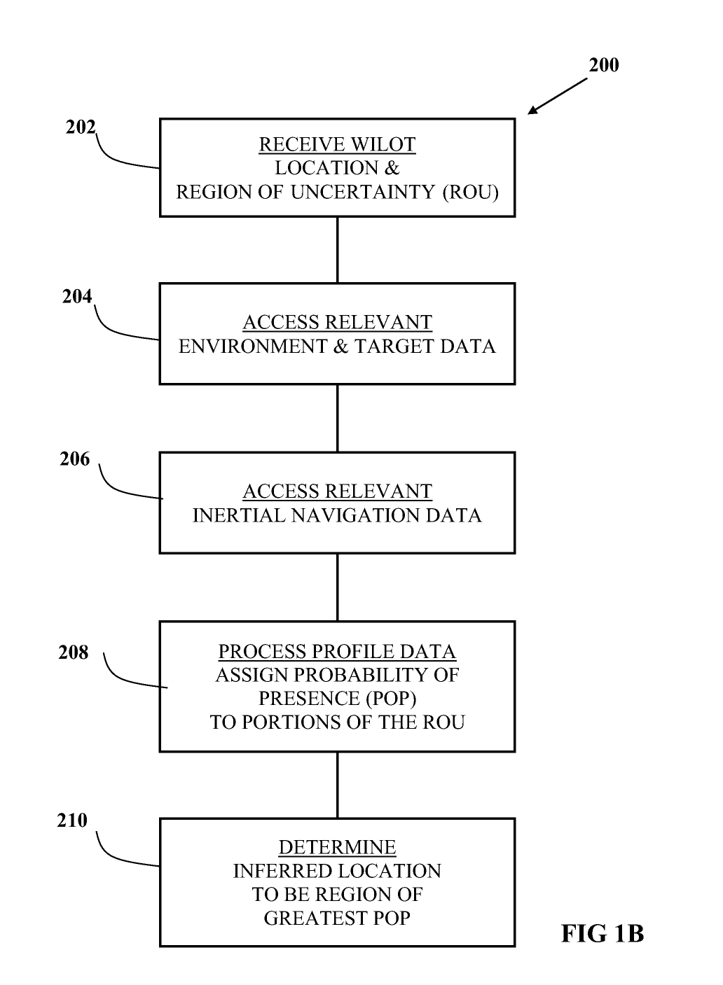

In the following detailed description, an ENVINT tracker, which uses environment and target profiles to improve accuracy of locations determined by a WILOT tracker, in accordance with an embodiment of the invention, is discussed with reference to FIGS. 1A and 1B. FIG. 1A schematically shows components of the ENVINT tracker, and FIG. 1B presents a flow diagram of an algorithm that ENVINT uses to provide a more accurate location and ROU for a tracker target than is provided by a WILOT tracker system.

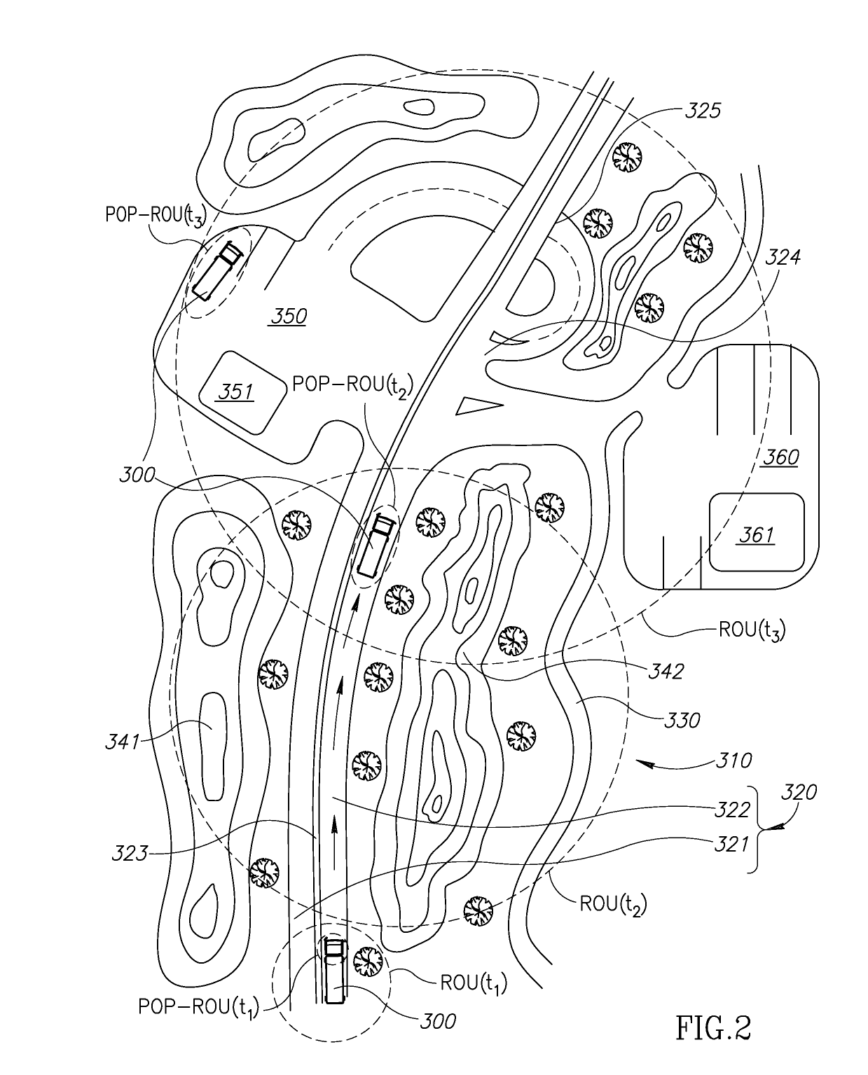

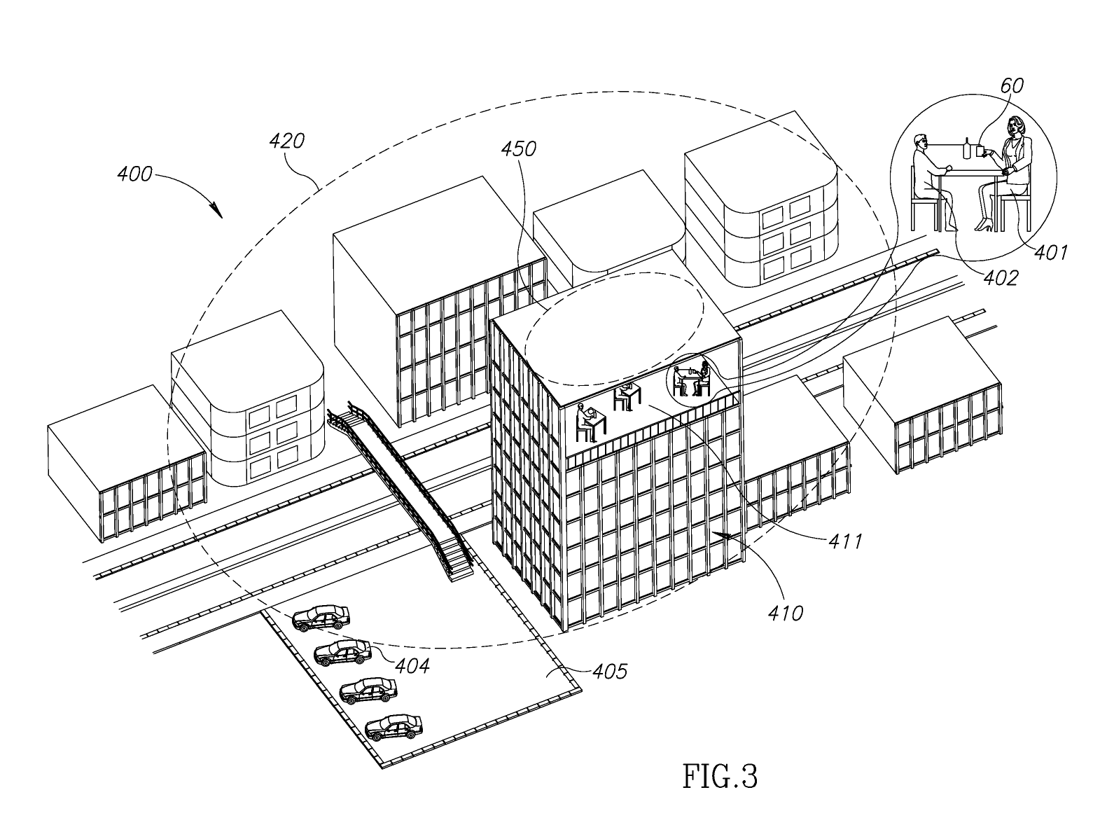

Operation of an ENVINT tracker using data from environment and target profiles to determine locations of a tractor-trailer as it moves through a rural environment is discussed with reference to FIG. 2. FIG. 3 schematically shows a mother and child in an urban environment. Operation of an ENVINT tracker in locating the mother and child to assist in providing shopping information responsive to their location and information provided by internet queries made by the mother is discussed with reference to the figure.

FIG. 1A schematically shows an ENVINT tracker 20 optionally comprising an “ENVINT” processor 22, at least one memory device 30 having stored therein environment and target profiles 31 and 32 respectively, and a mobile WILOT target terminal 40. Optionally, ENVINT tracker 20 comprises a wireless network interface 50 that enables the system wireless access to the internet 100.

In an embodiment of the invention, as schematically shown in FIG. 1A, ENVINT processor 22, memory device 30, internet interface 50, and WILOT target terminal 40 are housed in a same mobile device 60. Optionally, the mobile device comprises an inertial navigator 61. Optionally, the mobile device comprises a user interface 62, such as a keyboard, touch screen, microphone, and/or speaker. Mobile device 60 may be any of various mobile devices such as a mobile phone, personal digital assistant (PDA), laptop computer, or a tablet computer.

WILOT target terminal 40 comprises a receiver and/or transmitter represented by an antenna 42 for transmitting and/or receiving WILOT signals to and/or from an infrastructure of a WILOT tracker system, a controller 44, and associated computer instruction sets, application specific integrated circuits (ASICS), and/or systems on a chip, that the processor uses for processing the signals. The WILOT tracker system may be any of various WILOT tracker systems implementing any of various wireless location technologies, and may for example, comprise a GPS tracker system, a mobile phone network tracker system, and any combination of such systems.

In FIG. 1A WILOT terminal 40 is schematically shown communicating with satellites 102 of the GPS system and with base stations 104 of a mobile phone tracker. Optionally, controller 44 processes WILOT signals transmitted to the infrastructure and/or received from the infrastructure to determine a spatial location of WILOT target terminal 40, and thereby for device 60 and a bearer of the device, and an ROU for the location.

In an embodiment of the invention, ENVINT processor 22 uses the WILOT location and ROU, and data comprised in environment profile 31 and/or target profile 32 to improve accuracy with which the WILOT location is known and to generate an “ENVINT” ROU that is smaller than the WILOT ROU. Optionally, ENVINT processor 22 uses position information provided by inertial navigator 61 to generate an ENVINT ROU.

FIG. 1B shows a flow diagram of an algorithm 200 that ENVINT processor 22 optionally uses to provide an improved determination of the location of device 60. In a block 202 of algorithm 200, ENVINT processor 22 receives the WILOT location and ROU for the tracker target from WILOT controller 44. ENVINT uses the location and ROU to determine data in environment and target profiles 31 and 32 (FIG. 1A) that are relevant to a geographic region within the WILOT ROU. Optionally, the ENVINT processor acquires relevant environment and tracker target data via wireless network interface 50 from the internet.

Relevant environment data comprises data characterizing natural and/or manmade features that can influence motion of a tracker target in the WILOT ROU. Natural features of the ROU may comprise contour features of the ROU terrain, location of bodies of water, climate and/or ground cover. Manmade features of the ROU may comprise types and locations of highways, streets, sidewalks, and bridges, types and locations of buildings, and/or types and locations of commercial enterprises. Manmade features may also comprise types and locations of areas within boundaries of the ROU having specific character, such urban, suburban and rural regions of the ROU, and/or industrial, residential, commercial, amusement, and sports areas located within the ROU.

Relevant tracker target data comprises data characterizing physical and/or psychological features of the tracker target that can affect movement of the tracker target in the WILOT ROU. Physical features that characterize and affect mobility comprise the various means of transportation, a “conveyance”, that may be used to move around in the WILOT ROU, for example a type of vehicle, horseback, or “on-foot”. A tractor-trailer, car, motorcycle, motorized scooter, roller blades, bicycle, horseback, or on-foot, provide a target with different abilities to negotiate the WILOT ROU. A physical feature may also be a size of an individual, or the individual's gender.

Psychological features may comprise behavior patterns, preferences, and/or attitudes, that tend to vector a person to access or refrain from particular regions in an ROU. For example, a person having a phobia such as acrophobia might well be averse to climbing a mountain, the Eiffel Tower, or the Empire State Building and would not in general be expected to be found at these sites. Or, if a person is on a shopping trip and has requested addresses of sports stores via the internet, it is expected that the person will have an increased probability of being found in regions of a mall having known sports stores, or the sports stores for which the person was given addresses via the internet. Behavior patterns may comprise routes habitually traveled and places habitually visited by a person. Optionally, data defining such routes and places are provided from records of the person's movements

A person's age may also be considered a psychological feature. A person categorized as a child may, because of the psychology of his or her age, have an enhanced probability of being found in a playground or a toy store relative to a probability of an adult being found in a playground or toy store. Social environments can generate temporary mind sets that influence where a person may be located. An adult in a social environment of a young child, for example caring for a young child in the morning, may, because of the psychology of the temporary social environment generated by the adult child relationship, also have an enhanced probability of being in a toy store or a playground. A man “out for an evening with the boys” might well have an enhanced probability of being in a bar or sports stadium. A woman “out with the girls” for an afternoon might have an enhanced probability of being in a fashion boutique.

In a block 206, ENVINT processor 22 determines whether the inertial navigator provides data relevant to the tracker target motion within the ROU. For example, the inertial navigator might provide data indicating a change in altitude that can be used to locate the tracker target within the ROU.

In a block 208, the ENVINT processor uses the relevant profile data, and optionally the inertial navigator data to assign probabilities of presence (POPs) of the tracker target in different portions of the ROU. In a block 210 the ENVINT processor infers that the tracker target is located in a portion of the ROU having the greatest POP.

Whereas in the above description all components of an ENVINT tracker are described as being housed in a same mobile device (device 60 in FIG. 1A), practice of the invention is not limited to “centralized” ENVINT trackers in which all or substantially all of the system components are in a single device or location. An ENVINT tracker may have a distributed configuration with components at different locations. For example, memory device 30 may reside in at least one first stationary server, and ENVINT processor 22 may reside in a second server at a location different from a location of the at least one first server.

FIG. 2 schematically illustrates a scenario in which an ENVINT tracker in accordance with an embodiment of the invention operates to locate a tractor-trailer 300 making a cargo delivery. The tractor-trailer is assumed to belong to a delivery company having a fleet of trucks that it tracks using the ENVINT tracker to provide cargo delivery services to its customers. The ENVINT tracker is similar to an ENVINT tracker, such as ENVINT tracker 20 or variations thereof, described above. Optionally, the ENVINT tracker is configured as a distributed system having components of the ENVINT tracker comprised in a company dispatch center (not shown), tractor-trailer 300, and the internet.

In an embodiment of the invention, tractor-trailer 300 is provided with a mobile device comprising a WILOT target terminal 40, an inertial navigator 61, and an internet interface 50 (FIG. 1A) and/or a mobile telephone terminal, optionally WILOT terminal 40, for communicating with the dispatch center. Optionally, the company dispatch center maintains an ENVINT processor, such as ENVINT processor 22 shown in FIG. 1A, The ENVINT processor 22 may comprise an application stored on a company server, and/or an application, that is, a “cloud based” application, which is accessed by the dispatch center and/or by the tractor-trailer from the internet.

The dispatch center may have a target profile database, comprising a vehicle file for each of the company vehicles and a personal file for each of the company drivers. A company vehicle file may comprise data specifying the vehicle, its history, and service record. A driver personal file may comprise data characterizing physical and/or psychological features of a driver. A personal file may, for example, comprise personal information provided by the driver, and/or statistical information generated by the ENVINT tracker from past driving assignments, and/or information acquired from driver performance records. The dispatch center may also maintain, or have access to an environment profile, a database comprising data characterizing natural and manmade features of the geographical region for which it provides delivery services. Data in the company databases may be maintained on the company's own servers and/or be cloud based, that is, on the internet.

For a given delivery assignment, relevant target data from the company target profile 32 (FIG. 1A) includes data in the files of a driver and a vehicle assigned to make the delivery. Relevant data from the environment profile 31 (FIG. 1A) for the assignment comprises data characterizing a portion of the geographical service region of the company in which the vehicle moves in making the delivery.

By way of example, tractor-trailer 300 is assumed to be moving through a rural area 310 on its way to making a delivery. The tracker profile 32 comprises data characterizing psychological features of the driver driving the tractor-trailer indicating that the driver is a careful person, who generally maintains a steady vehicle speed on uncongested, open roadways, habitually takes off three quarters of an hour for lunch, and loves ice cream. The environment profile 31 has data that shows that rural area 310 comprises a divided highway 320 having northbound and southbound lanes 321 and 322 separated by a divider strip 323, and a scenic route 330. Stretches of hilly regions 341 and 342 line divided highway 320, and in rural area 310 there is no roadway access from divided highway 320 to scenic route 330 except in a region of rest areas 350 and 360 on the northbound and south bound sides respectively of divided highway 320. Rest areas 350 and 360 have restaurants 351 and 361 respectively. Restaurant 351 in rest area 350 is known for its ice cream. Rest area 350 is accessible from northbound lane 322 via a turnoff 324 and underpass 325.

On its way to making the delivery tractor-trailer 300, traveling northbound on lane 322 enters area 310 at a time t₁, and WILOT target terminal 40 determines that the tractor-trailer is located within an ROU(t₁) represented by a dashed circle, and transmits data defining ROU(t₁) to ENVINT processor 22. ROU(t₁) projects onto both northbound and south bound lanes 321 and 322 of divided highway 320. However, previous locations provided by the WILOT target terminal indicated that tractor-trailer 300 was moving north at a steady speed. ENVINT processor 22 determines that at the indicated steady speed, tractor-trailer 300 could not have reached a cross-over at which the tractor-trailer could have turned around to enter the southbound lane. The ENVINT processor therefore determines that the tractor-trailer has a very low, if not close to zero, probability of presence (POP) in the southbound lane, and a very high POP for being located in the northbound lane. In addition, given that the driver's personal file indicates that the driver generally maintains a steady vehicle speed with relatively little variance, ENVINT infers a relatively high POP for the tractor-trailer being in an ROU, a POP-ROU(t₁), indicated by a dashed circle, along the northbound lane that is smaller than ROU(t₁).

After entering area 310 tractor-trailer 300 travels northwards a relatively long length of divided highway 320 between stretches of hills 341 and 342 for which multipath and obscuration of line of sight to GPS satellites substantially degrades accuracy of locations provided for the tractor-trailer by WILOT target terminal 40. At a time t₂ the WILOT target terminal provides a location for the tractor-trailer defined by a very large ROU(t₂) that not only projects onto both lanes of divided highway 320 but also projects onto scenic route 330. However, the environment profile for area 210 indicates that there is no exit to scenic route 330 along the stretch of road between hills 341 and 342 and divider strip 323 effectively prevents the tractor-trailer from accessing southbound lane 321. In addition, ENVINT optionally determines an expected average and standard deviation for the speed of travel of the tractor-trailer responsive to the driver psychological characteristics and locations for the tractor-trailer along the northbound lane at times earlier than t₂. Using data from the environment profile and the determined average and standard deviation for the speed, ENVINT infers that the tractor-trailer is located in a POP-ROU(t₂) that is much smaller than ROU(t₂) and centered on northbound lane 322.

For a period of about twenty minutes ending at a time t₃ equal to about 12:15 PM, WILOT terminal 40 repeatedly provides similar, highly inaccurate locations and associated ROUs for the tractor-trailer. A location and ROU provided by WILOT terminal 40 for the tractor-trailer at time t₃ is indicated in FIG. 2 by a dashed circle labeled ROU(t₃). ROU(t₃) projects onto a large portion of area 210 that includes rest areas 350 and 360.

ENVINT 20 determines POPs for the tractor-trailer in ROU(t₃) responsive to time t₃, and the driver's personal penchant for ice cream. Since the WILOT has been providing same reading for about 20 minutes, t₃ is equal to 12:15 PM, and the driver is known (from the tracker profile) for stopping regularly for lunch ENVINT processor determines that the tractor-trailer is parked and the driver is at lunch in one of rest areas 350 and 360.

Given that the driver is also known to like ice cream, and restaurant 351 is famous for its ice cream, ENVINT determines a relatively high POP for the tractor-trailer being parked in rest area 350 and a low POP for being parked in rest area 360. The EVINT processor therefore infers that the tractor-trailer is parked in rest area 350 and located in a relatively small POP-ROU(t₃) that provides parking for tractor-trailers.

FIG. 3 schematically shows an urban area 400 in which ENVINT tracker 20 operates to locate a mother 401 and small son 402 in accordance with an embodiment of the invention. Mobile device 60 (FIG. 1A), which comprises ENVINT tracker 20, is assumed to be a mobile “smart” phone.

The mother and child have parked their car 404 in a parking lot 405 and have spent a late morning shopping. At about lunchtime, they enter a building 410 go up in an elevator to a restaurant in a top floor 411 of the building to have lunch. During lunch, the boy nags the mother to buy him a skate board. The tired mother uses wireless internet interface 50 (FIG. 1A) in her smart phone 60 to query an internet search engine, such as Bing, for sports stores as near as possible to her location. WILOT terminal 40 (FIG. 1A) in her phone indicates that she is located in a region having an ROU 420 that projects onto a relatively large region that includes a plurality of buildings in urban area 400.

ENVINT 20 receives data defining ROU 420 and accesses an environment profile for the ROU from the search engine. The environment profile provides not only a street map for the ROU but also details of the buildings in the area. Building details include not only location of the buildings, but also details of their physical structure and nature of establishments, commercial, industrial and/or residential, that occupy the buildings. In an embodiment of the invention, ENVINT 20 also receives data from inertial navigator 61.

Whereas data from inertial navigator 61 indicates that a location provided by the inertial navigator does not have an ROU smaller than ROU 420, it does indicate that the mother has undergone a substantial increase in altitude. The increase in altitude sensed by the inertial navigator reflects the elevator ride to the top floor of building 410. ENVINT processor 22 processes data in the environment profile for ROU 420 to determine that in the ROU, only top floor 411 of building 410 has a height that matches the change in altitude sensed by inertial navigator. The ENVINT processor therefore infers that the woman is in building 410, and in the top floor of the building, and generates a location for the woman having an ROU 450 that is much smaller than ROU 420.

The internet search engine from which the woman requested a sports store, receives ROU 450 from the woman's cell phone 60 and displays search results listing sports stores in building 410.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method of determining a location of a mobile target, the method comprising:
receiving data provided by a wireless location technology (WILOT) defining a first region of uncertainty (ROU) for a location of the target;
receiving environment data characterizing features of an environment in which the ROU is located;
receiving target data characterizing features of the target; and
using the environment data and the target data to determine a second ROU smaller than the first ROU for a location of the target.

2. A method according to claim 1 wherein using environment and target data comprises determining probabilities for presence of the target in different portions of the ROU.

3. A method according to claim 2 wherein using environment and target data comprises inferring presence of the target in a portion of the ROU having a highest probability of presence.

4. A method according to claim 1 wherein environment data comprises natural features of an environment.

5. A method according to claim 4 wherein natural features comprise at least one of terrain contour, ground cover, climate, and bodies of water.

6. A method according to claim 1 wherein environment data comprises manmade features of an environment.

7. A method according to claim 6 wherein manmade features of an environment comprise at least one of roadways, bridges, buildings, and commercial enterprises.

8. A method according to claim 1 wherein motion of the target is determined by a person, and target data comprises data characterizing psychological features of the person.

9. A method according to claim 8 wherein psychological features comprise at least one of preferences, dislikes, phobias, and behavioral habits.

10. A method according to claim 8 wherein psychological features comprise temporary mind sets generated by a social environment that vector a person toward or away from regions in an ROU.

11. A method according to claim 1 wherein target data comprises data characterizing physical features of a conveyance that moves the target.

12. Apparatus for determining a location of a mobile target, the apparatus comprising:
a wireless location technology (WILOT) that provides a first region of uncertainty (ROU) for a location of the target;
at least one memory having stored therein environment data characterizing features of an environment in which the ROU is located and target data characterizing features of the target; and
a processor configured to execute an instruction set that uses the first ROU, the environment data and the target data to determine a second ROU for the target that is smaller than the first ROU.

13. Apparatus according to claim 12 wherein the at least one memory comprises a cloud based memory.

14. Apparatus according to claim 12 wherein the processor comprises a programmable processor.

15. Apparatus according to claim 12 wherein the processor comprises an application specific integrated circuit (ASIC).

16. Apparatus according to claim 15 wherein the instruction set is executed by the ASIC.

17. Apparatus according to claim 12 and comprising a system on a chip that comprises the processor and a memory of the at least one memory.

18. Apparatus according to claim 12 and comprising a wireless network interface.

19. Apparatus according to claim 12 configured as a system on a chip.

20. A mobile communication device comprising an apparatus according to claim 12.
